(19) United States
(12) Patent Application Publication
(10) Pub. No.: US 2009/0077273 A1
(43) Pub. Date: Mar. 19, 2009

(54) Control Data Transfer

(76) Inventors: Barinder Singh Rai, Surrey (CA); Dax Ryn, Richmond (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/856,846

(22) Filed: Sep. 18, 2007

(51) Int. Cl. G06F 13/28

(52) U.S. Cl. 710/26

(57) ABSTRACT

An N-bit control word may be parsed into individual control bits and the individual bits may be inserted into the least significant bit (“LSB”) of N data words. The respective LSBs of the N data words may be mapped into particular bit positions of a control register. When a device receives the N data words, the respective LSBs of the N data may be stored in their designated bit position of the control register. The sender need not specify the address of the control register.

### FIELD OF INVENTION

The present invention is in the field of transferring control data within a computer system.

### BACKGROUND

When a computer system is first turned on, components and devices are usually in an undefined state and must be initialized for a specific mode of operation before they can be used. The process of initializing a device generally requires sending at least one control word to the device. Typically, many control words are sent. Within a computer system, control words are ordinarily transferred by a host over a bus and stored in control registers in the component.

Such components may be integrated circuits (“IC”), such as a display controller. It is desirable to reduce the number of pins on an IC because this reduces manufacturing cost. In addition, it is desirable to reduce the number of bus transactions between a host and an IC as each transaction consumes power. Drawbacks of known methods for transferring control words over a bus include contributing to an increased numbers of pins on ICs and increased power consumption. Thus, there is a need for improved methods and apparatus for transferring control data within a computer system.

### SUMMARY

According to one embodiment of the present disclosure, control registers are not provided with an address in the address space of a computer system. This contributes to reducing the size of the computer system address space. An N-bit control word is parsed into individual control bits and the individual bits are inserted, in one embodiment, into the least-significant bit (“LSB”) of N data words. In addition, the respective LSBs of the N data words are mapped into particular bit positions of a control register. When the component or device receives the N data words, the respective LSBs of the N data words are stored in their designated bit position of the control register. By inserting control bits into the LSBs of two or more data words, it is not necessary for the sender of the control word to specify an address in the address space of a computer system for the control register.

### BRIEF DESCRIPTION OF THE DRAWINGS

FIG. 1 illustrates an exemplary control word.

FIG. 2 illustrates exemplary data words and the mapping of particular bits of the data words into the control word of FIG. 1 according to one embodiment of the present disclosure.

FIG. 3 illustrates a method according to one embodiment of the present disclosure.

FIG. 4 is a simplified block diagram of a computer system having an extraction unit according to one embodiment of the present disclosure.

FIG. 5 is a simplified block diagram of the extraction unit of FIG. 4 according to one embodiment.

In the drawings and description below, the same reference numbers are used in the drawings and the description generally to refer to the same or like parts, elements, or steps.

### DETAILED DESCRIPTION

A control word is sometimes referred to as a command word, mode word, or control byte. A control word is a binary word, i.e., it is comprised of a sequence of bits. Usually a data sheet for the component or device defines the format for various control words. The individual bits of a control word are sometimes referred to as “control bits.” Each control bit may have a particular meaning related to an aspect of configuring the device. However, a control word by itself generally does not include information pertaining to a particular instruction or operation to be performed, such as a type of operation or specific operands (e.g., add, move, or jump). Nor does a control word, generally speaking, identify a source or a destination, i.e., an address in the device or system. Further, a control word ordinarily does not include data on which an operation is to be performed, or that is to be stored or otherwise processed by the device. Stated differently, a control word is not a conventional software instruction, an address, or data.

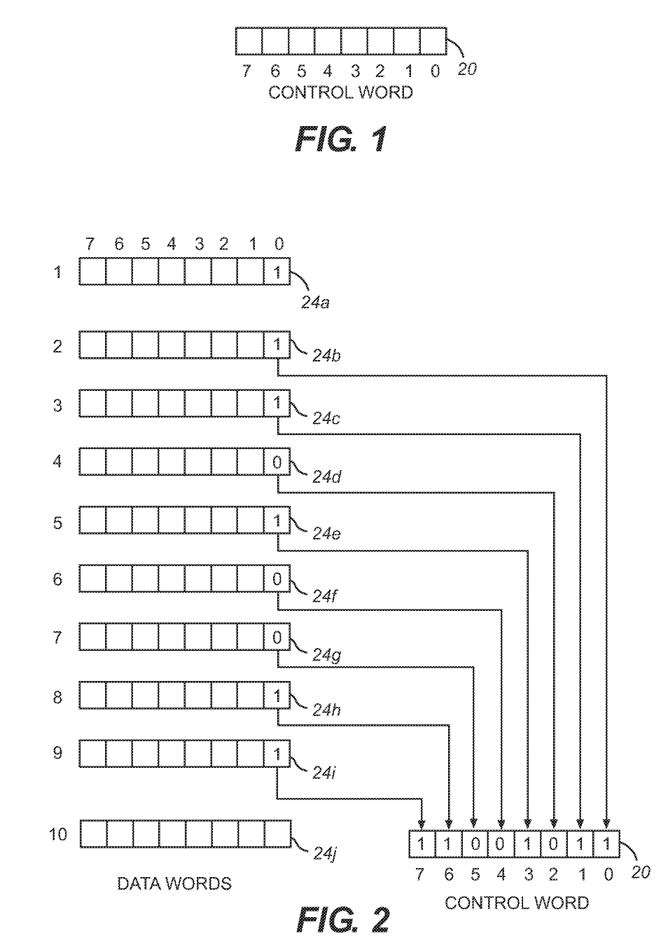

FIG. 1 illustrates an exemplary 8-bit control word 20. FIG. 2 illustrates ten exemplary data words 24 and the control word 20. The data words 24 are eight bits each. The individual bit positions in the control and data words are numbered 0-7. Bit 0 is the LSB and bit 7 is the most significant bit (“MSB”). The ten data words 24 are numbered 1-10. This numbering is intended to illustrate the order in which the data words are arranged in this example.

Control registers are often assigned a distinct address in the address space of computer system. To transfer control words to a device, the host specifies the address of a control register and the particular control word. If a single bus is used for transferring both addresses and data, the host specifies the register address in a first cycle and specifies the control word in the second cycle. If separate address and data buses are provided, the register address is placed on the address bus and the control word is placed on the data bus.

A component or device may provide an internal address for a control register within the component. These internal addresses are to be distinguished from the addresses in the address space of a system. According to methods, media, apparatus, and systems that embody the principles of the invention, control registers are not provided with an address in the address space of a computer, communication, or other system, even though such control registers may be provided with an address in the internal address space of a component or device. Where a control register does have an internal address, but does not have an address in the address space of the system, the host is unable to write data to or read data from the register. The control register is effectively “hidden” from the host.

In systems with a shared address bus, the number of control registers within the device determines, in part, the number of bus cycles needed to configure the device, and each bus cycle consumes power. In systems with separate address and data buses, the number of lines needed for the address bus, is determined by the total number of addresses needed. As the number of addresses in the address space of a system increases, additional address lines are needed. Thus, the size of a computer system's address space increases with each additional control register. This may require increasing the number of pins on an IC, which increases manufacturing costs.

The problems of increased power consumption and increased address-space size may be solved by not providing control registers with an address in the address space of a computer, communication, or other system. Each N-bit control word is parsed into individual control bits and the individual bits are inserted into the least-significant bit (“LSB”) of N data words. (To distinguish data words having inserted control bits from unmodified data words, the modified data words may be referred to as “data/control” words.) The N data/control words may be part of a larger set of data, such as a frame of pixel data. The set of data having the data/control words is transferred to the component or device. The component receives the set of data, identifies the N data/control words and extracts the respective LSBs. The component may then store each LSB in a particular bit position of a particular control register.

FIG. 2 shows how bit positions of the control word 20 may be mapped into the LSBs of a particular data words 24. The words 24b-24i become modified data words (data/control words) that have had a control bit inserted into their LSB. A particular bit of a control word 20 may be mapped into any data word 24. In one embodiment, control bits may be mapped into data words 24 based on the ordered position of the word 24 within the set of data. As shown in FIG. 2, sequential control bits may be mapped into sequential data words 24. For example, the LSB of word 24c is mapped into bit position 1, the LSB of data word 24d is mapped into bit position 2, and so on. Other sequential mappings may be employed. As another example, a frame of pixel data may include 12,000 8-bit pixels arranged in raster order, and a display controller may require ninety 8-bit control words. Seven hundred twenty of the 12,000 pixels may have the LSB of the pixel replaced with a control bit. The LSB of raster ordered pixels 2-9 may be mapped to control word 1, the LSB of raster ordered pixels 10-17 may be mapped to control word 2, and so on. Alternatively, the LSB of raster ordered pixels 10,002-10,009 may be mapped to control word 1, the LSB of raster ordered pixels 10,010-10,0017 may be mapped to control word 2, and so on. Thus, the relative position of a data word in a sequence of words determines the particular bit position in a control word into which the LSB of that data word may be mapped. In another alternative, sequential control bits may be mapped into alternate sequential data words 24, or the control bits may be mapped into sequential data words 24 spaced apart by larger or varying amounts. For example, a control bit may mapped into every fifth pixel, or a control bit may be mapped into the fifth, seventh, eighth, sixteenth, and twentieth pixels. Moreover, a control bit may be mapped into two or more bit positions of a data word. In one embodiment, control bits may be mapped into the two LSBs of a data word, i.e., positions 0 and 1.

According to one embodiment, a sender of the data words, such as a host, inserts control bits into the LSB of data words prior to sending the data words. While the sender may insert control bits into data words in a first set of data, e.g., at start-up, the sender may not insert control bits in second and subsequent sets of data. In one embodiment, the sender sends data words to a component or device without inserting control bits in the LSB of particular data words in a “standard” mode, and sends data/control words in an “insertion” mode. Further, a particular data word in the sequence of data words may be used to signal whether the sender is operating in standard or insertion mode. For instance, the first raster-ordered pixel in a frame may be used by the sender to signal whether the data words of the frame have been modified. In the example shown in FIG. 2, the first data word 24a is used to signal the mode of the sender. If the sender is operating in standard mode, the sender inserts a “1” into the LSB of the data word 24a. On the other hand, if the sender is operating in insertion mode, a “0” is inserted into the LSB of the data word 24a. The particular data word in the sequence of data words used to signal the mode of the sender may be any data word in the set, and may be referred to as a “data/mode” word. In one embodiment, the data/mode word may signal the mode that the sender will use when sending a subsequent frame. For example, the last word of a frame may be a data/mode word that signals that the next frame will not include data/control words. It is not critical that the sender have both the standard and insertion modes. In one embodiment, the sender may insert control bits into data words in every set of data.

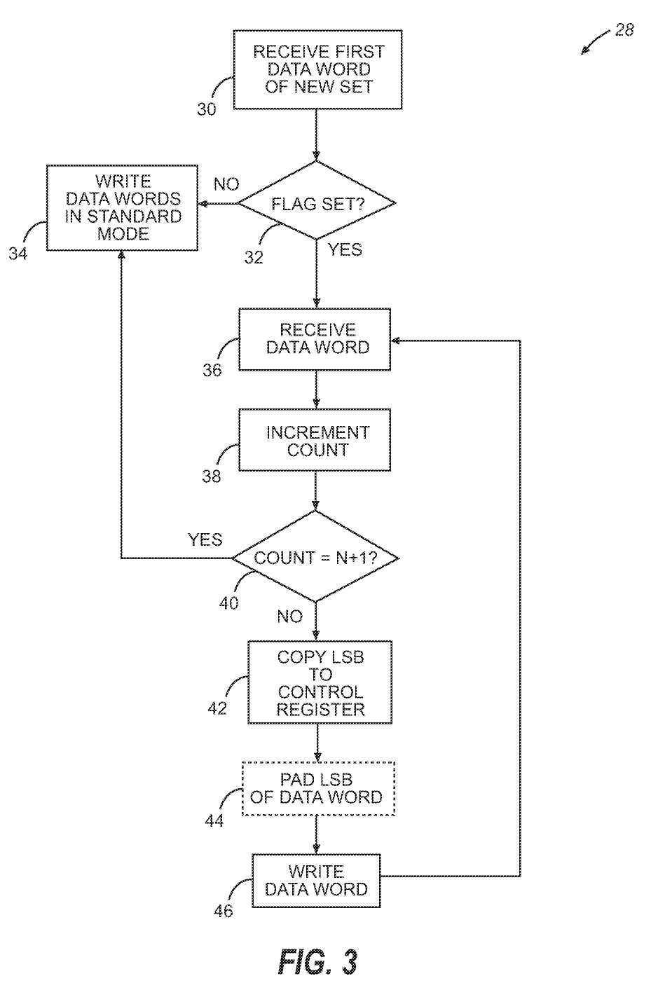

FIG. 3 illustrates a method 28 according to one embodiment of the present disclosure. The method 28 may be performed on a set of data words. A first data word 24a in the set is received (step 30). The first data word may be a data/mode word and the LSB of the first data word 24a is compared with a predetermined value, e.g., one. If the LSB of the first data word, i.e., the data/mode word, equals the predetermined value, an extraction mode flag is deemed to be set. On the other hand, if the LSB does not equal the predetermined value, the extraction mode flag is considered not to be set. If the extraction mode flag is not set, the sender sends data words in standard mode. If the extraction mode flag is not set, data words may be processed or written to a memory or other device according to whatever procedure is standard for a particular component or device (step 34). For instance, the data word may be associated with an address in the address space of the system and stored at that system memory address.

If the extraction mode flag is set, a subsequent data word of the set is received (step 36). The method 28 assumes that a particular number N of sequential data words immediately subsequent to the data/mode word are data/control words. FIG. 2 illustrates this assumption. A count of data words may be incremented (step 38) and the incremented count value tested to determine whether all of the data/control words have been received (step 40). If the N data/control words have been received, the method proceeds to step 34 where the remaining data words in the set may be processed or written in standard mode. If the count value test of step 40 is negative, the method advances to a step 42 in which the LSB of the data/control word is copied into a particular position in a control register. After the LSB is of the data/control word is copied to a control register, the LSB may be replaced or “padded” with a predetermined bit value, e.g., zero or one (step 44). Alternatively, the LSB of the data/control may be replaced with the value of next least significant bit of the data word. In another alternative, the LSB is of the first data word is not changed. The step 44 is shown with a dashed line to indicate that this step is optional. In step 46, the data/control word is processed or written to a memory or other device according to whatever procedure is standard for a particular component or device, and the method 28 returns to step 36 where a next subsequent data word is received. The steps 36-46 are then repeated for each of the N data/control words in the set. Each time the steps 36-46 are performed on a particular data/control word, the LSB of the data word may be copied into a different bit position or into a different control word. While the method 28 assumes that the data/control words are sequential data words immediately subsequent to the data/mode word, this assumption is not critical. Additional steps may be added to the method 28 to identify and select data/control words that may appear in other positions within the sequence of data.

The method 28 may be performed on a frame of pixels, each pixel being represented by a data word, the data words being arranged in raster order. In addition, an apparatus and system according to the present disclosure may operate on a frame of pixels arranged in raster order. An exemplary apparatus is described below. Before describing the exemplary apparatus, it may be helpful to briefly review several aspects of image data.

A raster scan pattern begins with the left-most pixel on the top line of a two-dimensional array, and proceeds pixel-by-pixel from left to right. When the end of line is reached, the scan pattern moves to next lower line, and again beginning with the left-most pixel, proceeds from left to right. The pattern repeats with each lower line until the end of the frame is reached. The attributes of a pixel may be represented in a variety of ways. A data word may define a pixel in terms of an RGB or YC_{R}C_{B} color model. In the RGB model, each primary color—red, green, and blue—represents an axis and the primary colors are added together to produce the desired color. Each RGB component may be eight bits. Alternatively, the R and B components may be five bits and the G component six bits. According to the 24-bit YC_{R}C_{B} color model, 8 bits may define a Y (luminance) value and 8 bits may each define C_{R} (chrominance-red) and C_{B} (chrominance-blue) color difference values.

A data/control word may be any data word used to partly or completely define a pixel. In one embodiment, a data/control word may be any data word used to define a pixel component. For instance, the LSB of the R, G, and B pixel components may be replaced with a control bit.

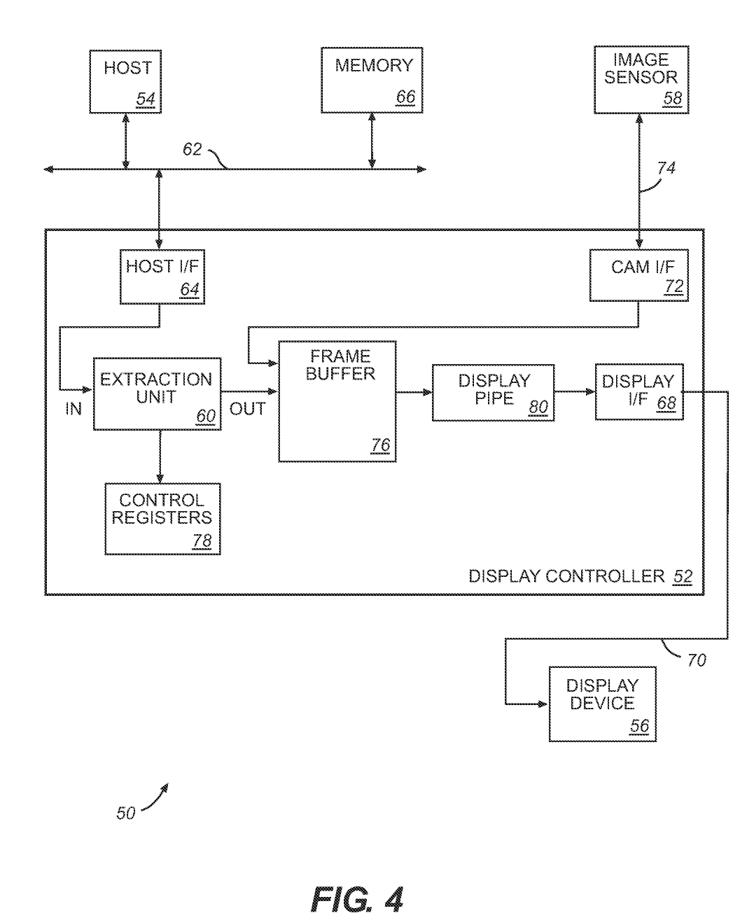

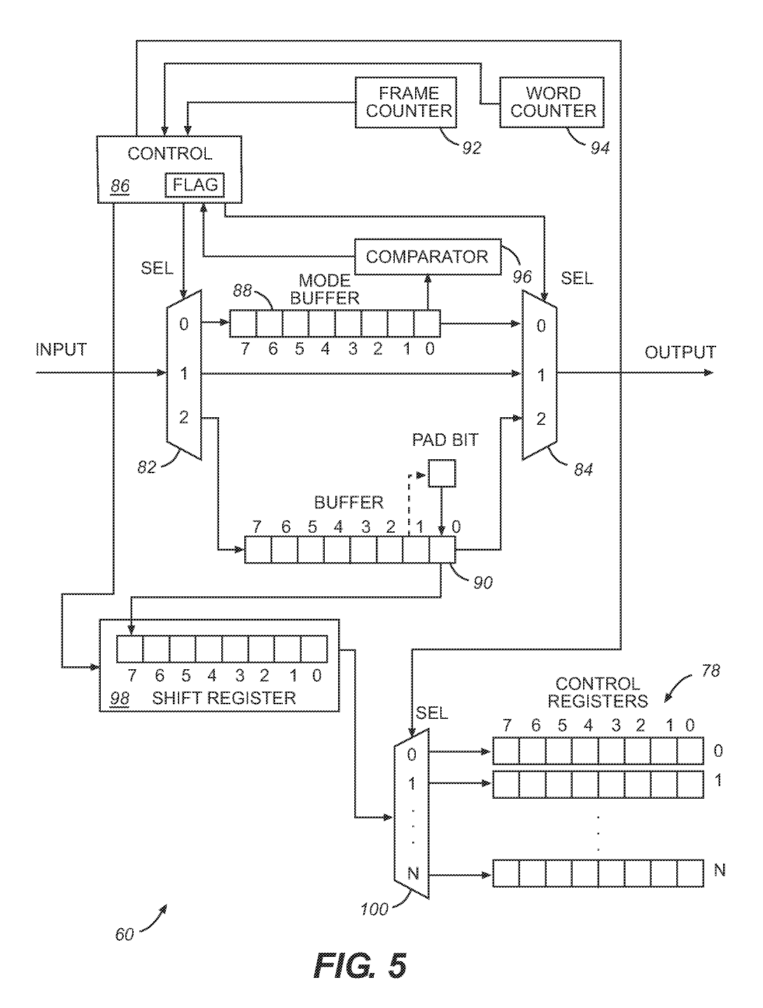

FIG. 4 is a simplified block diagram of a computer, communication, or other system 50 according to one embodiment of the present disclosure. The system 50 may be a mobile device (defined below). Where the system 50 is a mobile device, it is typically powered by a battery (not shown). The system 50 may include a display controller 52, a host 54, at least one display device 56 and one or more image data sources, such as image sensor 58. An address space may be defined for the system 50, where display controller 52, the host 54, the display device 56, and the image sensor 58 may all have addresses in the address space of the system 50.

Because the host 54 may be a source of image data, the term “image data source” is intended to include the host 54. While the system 50 may include multiple display devices and image data sources, this is not essential. In other embodiments, a single display device or a single image data source may be provided.

The display controller 52 interfaces the host 54 and image sensor 58 with the display device 56. The display controller 52 may also include an extraction unit 60. In one embodiment, the display controller 52 is a separate integrated circuit from the remaining elements of a system, that is, the display controller is “remote” from the host, image sensor, and display device.

The host 54 may send the display controller 52 control data in accord with the principles of the invention. Two examples of control words that the display controller 52 may require include the following: (a) a display panel configuration control word and (b) a panel control word. The display panel configuration word may specify the data format, panel data bus width, panel type (e.g., TFT, STN, HR-TFT, D-TFT), and panel resolution of a particular display device. The panel control word may specify whether the display device is monochrome or color. Other control words may be used to define horizontal and vertical display periods, pulse width, display mode, special effect parameters, system and pixel clock frequencies, and window display positions. In one exemplary display controller, as many as 100 registers may be provided for storing control words.

The host 54 is typically a microprocessor, but it may be a digital signal processor, a computer, or any other type of device or machine that may be used to control operations in a digital circuit. Typically, the host 54 controls operations by executing instructions that are stored in or on a machine-readable media. The host 54 communicates with the display controller 52 over a bus 62 to a host interface 64 in the display controller 52. Other devices may be coupled with the bus 62. For instance, a memory 66 may be coupled with the bus 62. The memory 66 may, for example, store instructions or data for use by the host 54, or image data that may be rendered using the display controller 52. The memory 66 may be an SRAM, DRAM, Flash, hard disk, optical disk, floppy disk, or any other type of memory. The memory 66 may have one or more addresses in the address space of the system 50.

A display device interface 68 may be included in the display controller 52. The display device interface 68 provides an interface between the display controller 52 and the display device 56. A display device bus 70 couples the display controller 52 and the display device 56. LCDs are typically used as display devices in mobile devices, but the display device 66 (defined below) may be any type of display device.

The image sensor 58 may be, for example, a charge-coupled device (“CCD”) or a complementary metal-oxide semiconductor (“CMOS”) sensor. A camera interface 72 (“CAM I/F”) may be included in the display controller 52. The camera interface 72 is coupled with the image sensor 58 and receives pixel data output on data lines of a bus 74. Typically, the camera interface 72 also receives vertical and horizontal synchronizing signals from the image sensor 58 and provides a clocking signal to the image sensor 58 for clocking pixel data out of the sensor. These signals may be transmitted via the bus 74 or via a separate bus (not shown).

The extraction unit 60 receives image data from the host 54 or memory 66 via the host interface 64. The extraction unit 60 may provide image data to a memory 76 for temporary storage before display. The extraction unit 60 is also coupled with control registers 78. The control registers 78 include at least one control register for storing a control word.

The memory 76 may be included in the display controller 52. In other embodiments, however, the memory 76 may be remote from the display controller. The memory 76 may be used as a frame buffer for storing image data (and may be alternately referred to as a frame buffer), but it may also be used for storing other types of data. The memory 76 may be of the SRAM type, but the memory 76 may also be a DRAM, Flash memory, hard disk, optical disk, floppy disk, or any other type of memory. The memory 76 may be coupled with other units within the graphics controller 52 as necessary or desired. The memory 76 may have one or more addresses in the address space of the system 50.

A display pipe 80 may be included in the display controller 52. The memory 76 may be coupled with an input to the display pipe 80. An output of the display pipe 80 may be coupled with the display interface 68. Thus, a frame of image data may be transferred from the memory 76 to the display device 56 via the display pipe 80 and display interface 68.

FIG. 5 is a simplified block diagram of the extraction unit 60 according to one embodiment. A data word may be input to the extraction unit 60 at an input to a first selecting circuit 82, and output from the unit 60 at an output of a de-selecting circuit 84.

A control circuit 86 is coupled with a selecting input to the first selecting circuit 82. The control circuit 86, in conjunction with the first selecting circuit 82, causes a data word input to the unit 60 to be transferred to one of three destinations. First, a data word may be transferred to a mode buffer 88. Second, a data word may be transferred to the de-selecting circuit 84. Third, a data word may be transferred to a buffer 90. A frame counter 92 and a data word counter 94 are coupled with the control circuit 86, and respectively signal the control circuit each time a new frame of data words and a new data word within a frame are received.

A data word may be transferred to a mode buffer 88 when the data word is a data/mode word of a new frame. For example, when the frame counter 92 signals that a new frame is input to the extraction unit 60 and the word counter signals that a first word of that frame is being input, the word may be transferred to the mode buffer. A comparator 96 samples a particular bit of the data/mode word stored in the mode buffer 88 and compares the sampled bit with a particular bit value. In one embodiment, the particular data bit is the LSB, e.g., bit “0” and the particular bit value is “1.” If the particular data bit does not equal the predetermined value, an extraction mode flag is considered not to be set, and the display controller 52 enters a “standard” mode. On the other hand, if the particular bit of the data/mode word equals the predetermined value, the extraction mode flag is deemed to be set and the display controller 52 enters an “extraction” mode. After sampling the LSB of the data/mode word, the word stored in mode buffer 88 is output from the unit 60. The host 54 may specify that the data/mode word is to be stored at a memory address in the address space of the system 50. For example, the host 54 may specify that the data/mode word is to be stored at particular address in the frame buffer 76. The data/mode word, in this case, is stored in the frame buffer 76 at the specified system address.

If a data word is transferred to the de-selecting circuit 84 in standard mode, the control circuit 84 selects the “1” output of the first selecting circuit 82, and the “1” input of the de-selecting circuit 84, causing the data word to be passed to directly to the output of the unit 60. In standard mode, the display controller 52 processes the data words of the frame according to whatever procedure is standard for the display controller. For example, in standard mode data words may be written to the memory 76 where they may be fetched for processing and rendering on the display device 56.

If a data word is transferred to the de-selecting circuit 84 in extraction mode, the control circuit 84 selects the “2” output of the first selecting circuit 82, and the “2” input of the de-selecting circuit 84. From the first selecting circuit 82, the data/control word is transferred to the buffer 90. The LSB of the data/control word transferred to the buffer 90 is copied to a register 98. In one embodiment, the register 98 is a shift register. The control circuit 84 may cause the bits in the shift register 98 to be shifted one position prior to copying the LSB of the data/control word. After the LSB of the data/control word has been copied to the register 98, the data/control word may be output from the extraction unit 60 via the de-selecting circuit 84. The LSB may be replaced with a pad bit before being output in any one of the ways described above with respect to step 44 of method 28. When each bit in the shift register 98 has been filled, the control circuit 84 may cause the bits in the shift register 98 to be transferred to a selected control register 78. The control circuit 84 selects a particular one of the control registers 78 using a second selecting circuit 100. When the control unit 86 determines that all of the data/control words of the frame have been received, the control unit 86 causes the extraction unit 60 to enter the standard mode. It is not critical that the shift register 98 be a shift register. In alternative embodiments, the shift register 98 may be any type of register or memory. In this alternative, the extraction unit 60 may include logic to store the particular bit of the data/control word in the appropriate bit of the register.

It is not essential that the extraction unit 60 have insertion and extraction modes of operation. The sender of data words may insert control bits in the LSB of particular data words every time it sends a frame of pixels or other set of data words, and the extraction unit 60 may extract LSBs from data/control words from every frame received. Similarly, it is not critical that the extraction unit 60 include components, such as mode buffer 88, for extracting a mode bit.

When a mode or control bit is inserted into the LSB of a data word, the data word becomes a data/mode word or a data/control word. A data word may represent a pixel or a pixel component. The mode or control bit may be different from the LSB it replaces. As such the color value of a pixel may change. When the display controller operates in extraction mode, after a frame of image data has been stored in the frame buffer, the pixels are fetched and transferred to the display where they are rendered. As data/mode and data/control words are stored in the frame buffer, some of the fetched pixels may include changed colors. In general, the color difference may be slight or imperceptible because only the LSB of a pixel or a pixel component is modified. In addition, only a relatively small number of the total pixels in a frame are modified. Further, only one frame in a sequence of frames is modified. In video, a single frame may be displayed for only a fraction of a second.

One aspect of the present disclosure relates to a method, apparatus, and media for the insertion of control bits. In one embodiment, an insertion method includes a first step of determining the control word or words for a particular component or device. The control words may be determined manually with reference to a data sheet for the device. In a second step, the control words are parsed into individual bits and mapped to a particular bit position in a plurality of data words. FIG. 2 shows a mapping of individual bits of a control word 20 to a plurality of data words 24b-24i. In a third step, the parsed control bits are respectively inserted into the LSB of designated data words. In a fourth step, the data word having inserted control bits may be sent to a component or device. A method for inserting control bits may be performed by a host or any other image data source in hardware or software.

Having generally described exemplary embodiments, several aspects and alternatives of the present disclosure may be further described.

The data words 24 words according may be may be any length of at least two bits. In addition, control words 20 may be may be any length. Moreover, data and control words may have the same or different lengths. In addition, any number of the data/control words may be included in a set of data words.

In the example shown in FIG. 2, the LSB of the data words 24 are mapped into a particular bit position in a control word 20. In alternative embodiments, a bit of a data word other than the LSB may be mapped into a particular bit position in a control word. Further, more than one bit of a data word may be mapped into bit positions of a control word.

In the example of FIG. 2, the data words are arranged in a particular order or sequence. It should be appreciated that embodiments of the present disclosure may be practiced on a set of data of any type that are arranged in any order. In addition, in the example of FIG. 2, the data/mode word is the first word in the sequence, with the data/control words following. However, embodiments of the present disclosure are not limited to this exemplary arrangement of data words. The data/mode word may occupy any position in the ordered arrangement of data words. Similarly, the data/control words may occupy any positions in the ordered arrangement of data words. The data/control words may be grouped in one or more blocks of consecutive data/control words or they may be interspersed among unmodified data words.

As mentioned above, control data is often transmitted to a device when a computer system is first turned on. However, control data may be transmitted to a device at any time. In one embodiment, control data is transmitted to a component or device according to the present disclosure when the system is first turned on or booted-up. In another embodiment, control data may be transmitted to a device any time there is a need to change control data.

Method embodiments of the present disclosure may be implemented in hardware or software, or in a combination of hardware and software. Where all or part of a method is implemented in software, a program of instructions may include one of more steps of a method and the program may be embodied on machine-readable media for execution by a machine. Machine-readable media may be magnetic, optical, or mechanical. A few examples of machine readable media include floppy disks, Flash memory, optical disks, bar codes, and punch cards. Some examples of a machine include disk drives, processors, USB drives, optical drives, and card readers. The foregoing examples are not intended be exhaustive lists of media and machines. In one embodiment, a method according to the present disclosure may be practiced in a computer or communication system, such as the system 50.

Embodiments of the claimed inventions may be used in a “mobile device.” A mobile device, as the phrase is used in this description and the claims, means a computer or communication system, such as a mobile telephone, personal digital assistant, digital music player, digital camera, or other similar device. Embodiments of the claimed inventions may be employed in any device capable of processing image data, including but not limited to computer and communication systems and devices generally.

The term “display device” is used in this description and the claims to refer to any of device capable of rendering images. For example, the term display device is intended to include hardcopy devices, such as printers and plotters. The term display device additionally refers to all types of display devices, such as CRT, LED, OLED, and plasma devices, without regard to the particular display technology employed.

In this document, references may be made to “one embodiment” or “an embodiment.” These references mean that a particular feature, structure, or characteristic described in connection with the embodiment is included in at least one embodiment of the claimed inventions. Thus, the phrases “in one embodiment” or “an embodiment” in various places are not necessarily all referring to the same embodiment. Furthermore, particular features, structures, or characteristics may be combined in one or more embodiments.

Although embodiments have been described in some detail for purposes of clarity of understanding, it will be apparent that certain changes and modifications may be practiced within the scope of the appended claims. Accordingly, the described embodiments are to be considered as illustrative and not restrictive, and the claimed inventions are not to be limited to the details given herein, but may be modified within the scope and equivalents of the appended claims. Further, the terms and expressions which have been employed in the foregoing specification are used as terms of description and not of limitation, and there is no intention in the use of such terms and expressions to exclude equivalents of the features shown and described or portions thereof, it being recognized that the scope of the inventions are defined and limited only by the claims which follow.

I claim:

1. A method for transferring a control bit, comprising the steps of:
replacing a first one of the bits of a first data word of at least two bits with a first control bit, thereby forming a first data/control word; and
extracting the first control bit from the first data word for storage in a first memory.

2. The method of claim 1, further comprising associating an address in a first address space with the first data/control word, wherein the first address space omits an address for the first memory.

3. The method of claim 1, further comprising transferring the first data/control word.

4. The method of claim 1, wherein the first one of the bits is stored in a first bit position in the first memory, further comprising:
replacing a second one of the bits of a second data word of at least two bits with a second control bit, thereby forming a second data/control word;
transferring the second data/control word; and
extracting the second control bit from the second data word for storage in a second bit position in the first memory.

5. The method of claim 1, further comprising a step of storing each bit of the first data/control word other than the first one of the bits at an address in the first address space.

6. The method of claim 5, further comprising storing a replacement bit for the first one of the bits the address in the first address space.

7. The method of claim 1, wherein the first one of the bits is in the least-significant-bit position of the data/control word.

8. The method of claim 1, wherein the steps are contained in a program of instructions embodied on a machine-readable medium for execution by a machine.

9. The method of claim 1, wherein the data word defines pixel information.

10. A display controller comprising:
a first memory to store at least one control bit;
a unit to select at least one data word belonging to a set of data words, the selected data word having at least two bits, and to copy at least one bit of the selected data word to the first memory, wherein a first address space fails to include an address for the first memory.

11. The display controller of claim 10, further comprising a second memory, wherein the first address space includes an address for the second memory, and the first unit stores the selected data word in the second memory.

12. The display controller of claim 10, wherein the set of data words are arranged in an ordered sequence, and the first unit selects the data word based on the sequential position of the data word.

13. The display controller of claim 12, wherein the set of at least two data words are arranged in a raster sequence.

14. The display controller of claim 10, wherein the one bit of the selected data word has less significance than the most-significant bit.

15. The display controller of claim 10, wherein the data word defines a pixel component.

16. A system, comprising:
a display controller having
a first memory to store at least one control bit;
a second memory; and
a first unit to store two or more words in the second memory, and to store at least one bit of a selected first word of the words in the first memory.

17. The system of claim 16, further comprising a host to transmit the words to the display controller and to replace a first one of the bits of the selected first word with a first control bit.

18. The system of claim 17, wherein the host is capable of transmitting the words to addresses in a first address space, and the first address space excludes the first memory.

19. The system of claim 17, wherein the first unit determines to store the at least one bit of the selected first word in the first memory based on the value of a particular bit of a second word transmitted by the host.

20. The system of claim 16, wherein the at least one control bit defines, at least in part, the mode of operation of the display controller.

21. The system of claim 16, wherein the words define pixels.
